(19) United States
(12) Patent Application Publication
(10) Pub. No.: US 2025/0251593 A1
(43) Pub. Date: Aug. 7, 2025

(54) IMAGE PROJECTION APPARATUS

(71) Applicants: Mayu BANNO, Kanagawa (JP); Toshiharu HACHISUKA, Kanagawa (JP); Kazuhiro FUJITA, Tokyo (JP); Kasumi NAKAMURA, Kanagawa (JP)

(72) Inventors: Mayu BANNO, Kanagawa (JP); Toshiharu HACHISUKA, Kanagawa (JP); Kazuhiro FUJITA, Tokyo (JP); Kasumi NAKAMURA, Kanagawa (JP)

(21) Appl. No.: 19/026,913

(22) Filed: Jan. 17, 2025

(30) Foreign Application Priority Data
Feb. 7, 2024 (JP) 2024-017169

(51) Int. Cl. G02B 27/01; G03B 21/16; G03B 21/20; G03B 21/28

(52) U.S. Cl. CPC G02B 27/0101; G03B 21/16; G03B 21/204; G03B 21/28; G02B 2027/0118; G02B 2027/014

(57) ABSTRACT

An image projection apparatus includes a light source to emit light, an image display element, and a projection optical system. The image display element modulates the light emitted from the light source unit to form an image with the modulated light. The projection optical system projects the image formed by the image display element. Both the light emitted from the light source and the image projected by the projection optical system satisfy A>B and A>C, where A denotes a radiation energy of light having a wavelength of 510 nm or more and 610 nm or less, B denotes a radiation energy of light having a wavelength of less than 510 nm, and C denotes a radiation energy of light having a wavelength of greater than 610 nm.

### CROSS-REFERENCE TO RELATED APPLICATIONS

This patent application is based on and claims priority pursuant to 35 U.S.C. § 119(a) to Japanese Patent Application No. 2024-017169, filed on Feb. 7, 2024, in the Japan Patent Office, the entire disclosure of which is hereby incorporated by reference herein.

### BACKGROUND

### Technical Field

The present disclosure relates to an image projection apparatus.

### Related Art

An image projection apparatus such as a projector that projects a monochrome image is known.

An image projection device utilizing light having a wavelength range around 550 nm is disclosed to enhance the brightness of the projected image.

### SUMMARY

An embodiment of the present disclosure provides an image projection apparatus comprising: a light source to emit light; an image display element to modulate the light emitted from the light source unit to form an image with the modulated light; and a projection optical system to project the image formed by the image display element, wherein both the light emitted from the light source and the image projected by the projection optical system satisfy: A>B and A>C, where A denotes a radiation energy of light having a wavelength of 510 nm or more and 610 nm or less, B denotes a radiation energy of light having a wavelength of less than 510 nm, and C denotes a radiation energy of light having a wavelength of greater than 610 nm.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an image projection apparatus;

FIG. 2 is a schematic diagram of a configuration of a light source unit of the image projection apparatus in FIG. 1;

FIG. 3 is a schematic diagram illustrating a configuration of a phosphor wheel included in the light source unit of FIG. 2, and is a plan view of the phosphor wheel as viewed in a direction along the rotation axis of the phosphor wheel;

FIG. 4 is a schematic diagram illustrating a configuration of a phosphor wheel included in the light source unit of FIG. 2, and is a cross-sectional view of the phosphor wheel as viewed in a direction intersecting the rotation axis of the phosphor wheel;

FIG. 5 is a diagram illustrating a spectral distribution of light emitted from the phosphor wheel of the light source unit in FIG. 2;

FIG. 6 is a schematic diagram of another configuration of a light source unit including an image projection apparatus in FIG. 1;

FIG. 7 is a diagram illustrating a configuration of a phosphor wheel included in the light source unit of FIG. 6;

FIG. 8 is a diagram of a ratio of radiation intensity of yellow fluorescence in each wavelength range of light projected from an image projection apparatus 1, specifically illustrating the radiation intensity of 510 nm or more and 610 nm or less;

FIG. 9 is a diagram of a ratio of radiation intensity of yellow fluorescence in each wavelength range of light projected from the image projection apparatus 1, specifically illustrating the radiation intensity between 428 nm and 688 nm;

FIG. 10 is a diagram illustrating a configuration of a projection optical system included in the image projection apparatus in FIG. 1;

FIG. 11 is a diagram illustrating a configuration of multiple lenses included in the image projection in FIG. 1;

FIG. 12 is a diagram illustrating a relation between the reflectance of a mirror included in the image projection apparatus in FIG. 1 and the wavelength;

FIG. 13 is a diagram illustrating a relation between the transmittance of a lens included in the image projection in FIG. 1 and the wavelength;

FIG. 14 is a schematic diagram of another configuration of a light source unit included in an image projection apparatus;

FIG. 15 is a schematic diagram illustrating a configuration of a static phosphor unit included in the image projection apparatus in FIG. 14;

FIG. 16 is a schematic diagram of a configuration of a light source unit included in an image projection apparatus;

FIG. 17 is a diagram of a spectral distribution of light emitted from a light source unit included in the image projection apparatus in FIG. 16;

FIG. 18 is a diagram illustrating color distribution per cycle in the Digital Light Processing (DLP) method;

FIG. 19A is a schematic perspective view of a configuration example of a wearable display device which is an example of a projector;

FIG. 19B is an illustration of a part of the configuration of a wearable display device according to an application example;

FIGS. 19C-a and 19C-b are schematic diagrams each illustrating an application example of a wearable display device;

FIG. 19D is a diagram illustrating a form of a helmet with a visor including a light guide plate in a wearable display device according to an application example;

FIGS. 19E-a and 19E-b are schematic diagrams each illustrating an application example of a wearable display device;

FIG. 20A is a schematic diagram of an automobile equipped with a head-up display device which is an example of a projector;

FIG. 20B is a schematic diagram of a head-up display device according to an application example; and

FIG. 20C is a schematic diagram of a head-up display device according to an application example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to one aspect of the present disclosure, an image projection apparatus is provided that can project an image that is easy to visually recognize even in a bright place.

Referring to the drawings, an image projection apparatus is described in detail according to embodiments of the present disclosure. The embodiments described below illustrate an image projection apparatus for embodying the technical concept of this embodiment, but are not limited to these examples.

The dimensions, materials, and shapes of components, relative arrangements thereof, and the like described below are not intended to limit the scope of the present disclosure unless otherwise specified and are only examples for explanation. For example, the size of these elements and the relative positions of these elements may be exaggerated for illustration in the drawings. In the description given below with reference to the drawings, like reference signs denote like elements, and overlapping description may be simplified or omitted as appropriate.

### Configuration of Image Projection Apparatus

### Overall Configuration

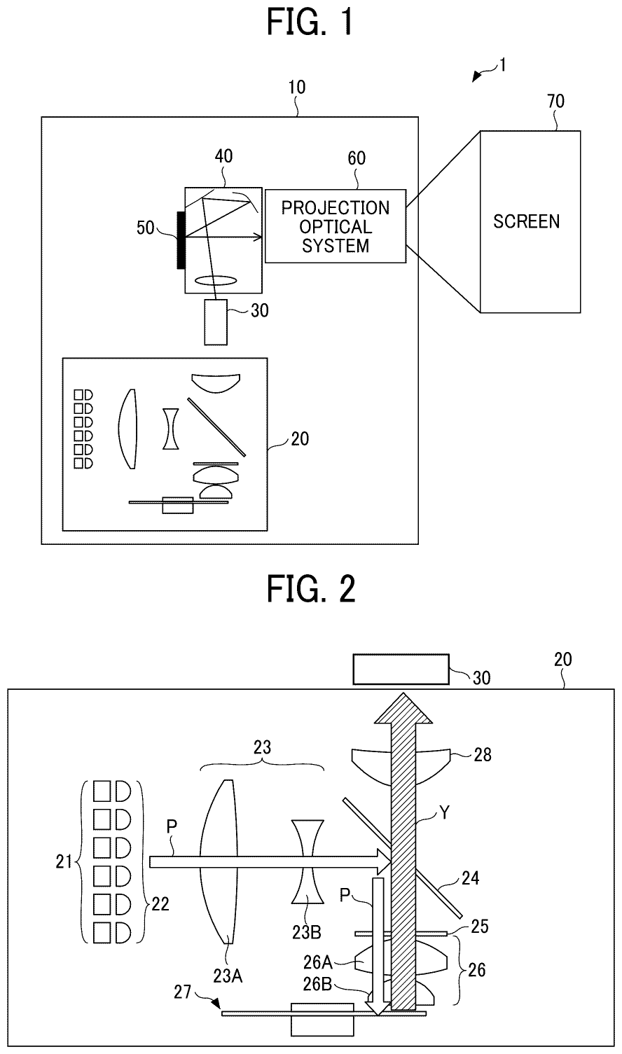

FIG. 1 is a diagram illustrating the entire configuration of an image projection apparatus 1. FIG. 1 illustrates the interior of the image projection apparatus 1 in a see-through view.

The image projection apparatus 1 includes a light source unit 20, an image display element 50 that modulates light emitted from the light source unit 20 to form an image with the modulated light, and a projection optical system 60 that projects the modulated light from the image display clement 50 to form an image with the modulated light. The image projection apparatus can expand and project an image, formed by the modulated light from the image display element 50, onto the screen 70 using the projection optical system 60.

An image projection apparatus such as a projector that projects a monochrome image is known. In recent years, the usage of image projection apparatuses has increasingly shifted toward applications such as guidance displays and drawing projections, where brightness is prioritized over the width of the color gamut. In such applications, the image projection apparatus is required to offer improved visibility and brightness, ensuring that the projected image can be easily viewed even in bright environments.

In FIG. 1, the light source unit 20 emits light that satisfies A>B and A>C, where A denotes the radiation energy of light having wavelengths of 510 nm or more and 610 nm or less, B denotes the radiation energy of light having wavelengths less than 510 nm, and C denotes the radiation energy of light having wavelengths greater than 610 nm. The image projected by the projection optical system 60 is also formed of light satisfying A>B and A>C.

The light satisfying A>B and A>C is light having high visibility to a person. For light satisfying A>B and A>C, such as light having wavelengths of 510 nm or more and 610 nm or less, the perceived brightness (in lumens (lm)) by human eyes varies depending on the wavelength, even if the light has the same power (radiant flux “W”). Light having a wavelength of 555 nm is perceived as the brightest. The relative luminous efficiency is the ratio of brightness at other wavelengths to the brightness at 555 nm. According to JISZ8785:2019, the relative luminous efficiency is 50% or higher within the wavelength range of 510 nm or more and 610 nm or less. Further, 510 nm and 610 nm are approximately positioned at the inflection points of the curve.

The image projection apparatus I can project an image an easily recognizable by a person by emitting light that satisfies A>B and A>C, and by projecting an image formed from such light. For example, the image projection apparatus 1 can project an easily recognizable image by emitting light that satisfies A>B and A>C, and by projecting an image formed from light having wavelengths of 510 nm to 610 nm, which have high relative luminous efficiency. According to FIG. 1, an image projection apparatus 1 can project an image that is easy to visually recognize even in a bright place.

From the viewpoint of projecting an image that is easily visually recognized even in a bright place, it is more preferable that the light source unit 20 emits light that satisfies A>B+C, and it is further preferable that the light source unit 20 emits light that satisfies at least one of A≥2B and A≥2C.

The image projection apparatus 1 illustrated in FIG. 1 includes a housing 10, light source unit 20, a light homogenizer 30, an illumination optical system 40, image display element 50 and projection optical system 60. The housing 10 houses the light source unit 20, the light homogenizer 30, the illumination optical system 40, the image display element 50, and the projection optical system 60. The light homogenizer 30 mixes the light beams emitted from the light source unit 20 to homogenize their light intensities. For example, the light homogenizer 30 can be a light tunnel formed by four mirrors, a glass rod, a microlens array, or a diffusion plate. The illumination optical system 40 substantially uniformly illuminates the image display element 50 with the light beam homogenized by the light homogenizer 30. The illumination optical system 40 includes, for example, one or more lenses or one or more reflecting surfaces. The image display element 50 is, for example, a light valve, such as a Digital Micromirror Device (DMD), a transmissive liquid crystal panel, a reflective liquid crystal panel, or a mask substrate, such as a photomask with a hole positioned to allow light to pass through. The DMD is an image display element that works by tilting the micromirrors of each pixel, based on ON (lighting) or OFF (extinction) of each pixel, directing the light from micromirrors in the ON state to the projection optical system. The projection optical system 60 includes one or more lenses, and enlarges and projects the image formed by the image display element 50 onto the screen 70.

### Light Source Unit 20

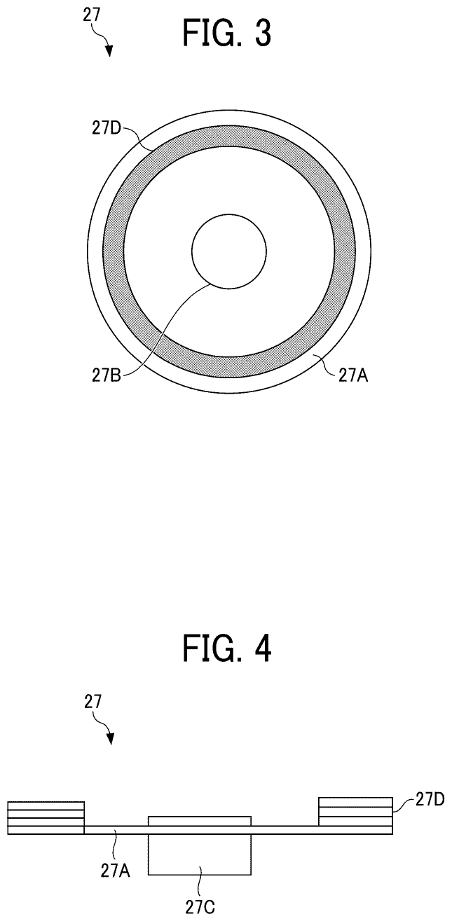

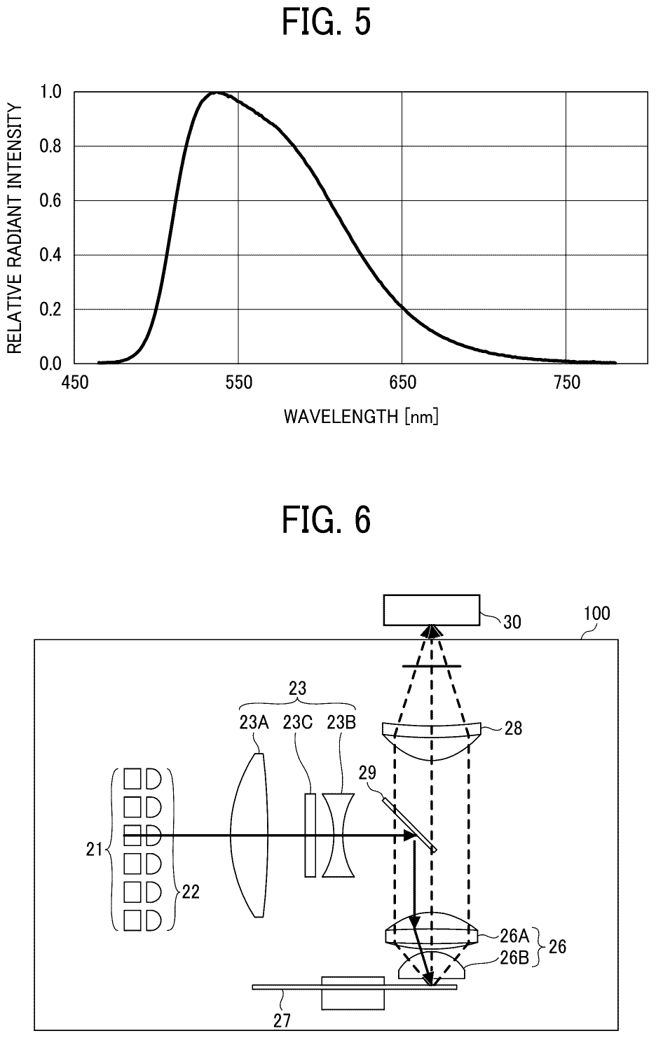

An example of a configuration of the light source unit 20 included in the image projection apparatus I will be described with reference to FIGS. 2 to 5. FIG. 2 is a schematic diagram of light source unit 20 of the image projection apparatus 1. FIG. 3 is a first schematic diagram illustrating the configuration of a phosphor wheel 27 included in the light source unit 20 of FIG. 2, and is a plan view of the phosphor wheel 27 as viewed in a direction along the rotation axis of the phosphor wheel 27. FIG. 4 is a second schematic diagram illustrating the configuration of the phosphor wheel 27 included in the light source unit 20 of FIG. 2, and is a cross-sectional view of the phosphor wheel 27 as viewed in a direction intersecting the rotation axis of the phosphor wheel 27. FIG. 5 is a diagram illustrating a spectral distribution of light emitted from the phosphor wheel 27 included in the light source unit 20 of FIG. 2.

The light source unit 20 includes an excitation light sources 21 and a phosphor wheel 27 that receives light emitted from the excitation light sources 21 and emits light having a wavelength different from that of the light from the excitation light sources 21. In FIG. 2, the light source unit 20 includes a collimator lens 22, a first optical system 23, a polarization beam splitter 24, a 4/1 wave plate 25, a second optical system 26, and a condenser lens 28. The excitation light source 21, the collimator lens 22, the first optical system 23, the polarization beam splitter 24, the 4/1 wave plate 25, the second optical system 26, the phosphor wheel 27, and the condensing lens 28 are arranged in this order in the propagation direction of light. All the elements except the excitation light source 21 in light source unit 20 form a light source optical system. The first optical system 23 includes a first lens 23A and a second lens 23B. The second optical system 26 includes a third lens 26A and a fourth lens 26B.

The excitation light source 21 includes multiple semiconductor lasers as multiple solid-state light sources. The semiconductor lasers may be laser diodes. Using multiple solid-state light sources as the excitation light source 21 allows for increased light extraction efficiency from the light source unit 20 while also reducing its size. In the excitation light source 21 illustrated in FIG. 2, six semiconductor lasers are arranged. In other implementations, additional semiconductor lasers may be arranged in rows along a depth direction. For example, in an implementation including four semiconductor lasers in each row arranged along a virtual side surface intersecting with the light emission direction of the excitation light source 21, 6×4=24 semiconductor lasers may be arranged in a two-dimensional array.

Each of the multiple laser diodes in the excitation light source 21 emits light, such as blue laser light, with a central wavelength of 455 nm in the blue band. This light serves as excitation light P to excite the phosphor in the phosphor region 27D of the phosphor wheel 27.

The excitation light P emitted from each of the multiple semiconductor lasers included in the excitation light source 21 is linearly polarized light having a constant polarization state, and is coherent light. The multiple semiconductor lasers in the excitation light source 21 are arranged to produce S-polarized light relative to the incident surface of the polarization beam splitter 24. The excitation light P emitted by each light source of the excitation light sources 21 is not limited to light in the blue band and may be light having wavelengths that can excite the fluorescent body in the phosphor region 27D of the phosphor wheel 27. The number of light sources included in the excitation light source 21 is not limited to 24, and may be 1 or more and 23 or less, or 25 or more. The excitation light source 21 can be configured, for example, as a light source array in which multiple light sources are arranged on a substrate, allowing for flexibility in its specific design.

A collimator lens group includes 24 collimator lenses 22 corresponding to 24 light source of the excitation light sources 21. Each collimator lens 22 adjusts the excitation light B emitted by the corresponding light source of the excitation light sources 21 to substantially parallel light. The number of collimator lenses 22 can be increased or decreased in accordance with an increase or a decrease in the number of light sources of the excitation light sources 21 so as to correspond to the number of light sources of the excitation light sources 21.

The polarization beam splitter 24 is coated to reflect S-polarized light in the wavelength band of the excitation light P from the first optical system 23, while transmitting P-polarized light in the wavelength band of the excitation light P from the first optical system 23 and yellow fluorescence Y from the phosphor wheel 27. In FIG. 2, the plate-type polarization beam splitter 24 is used, but a prism-type polarization beam splitter 24 may be used. In FIG. 2, the polarization beam splitter 24 reflects S-polarized light in the wavelength band of the excitation light P and transmits P-polarized light. Conversely, the P-polarized light in the wavelength band of the excitation light P can be reflected, and the S-polarized light may be transmitted.

The ¼ wave plate 25 is arranged in a state in which the optical axis thereof is inclined by 45 degrees with respect to the linear polarized light of the excitation light P reflected by the polarization beam splitter 24. The ¼ wave plate 25 converts the excitation light P reflected by the polarization beam splitter 24 from the linear polarized light into circular polarized light.

The second optical system 26 entirely has a positive power and includes a third lens 26A that is a positive lens and a fourth lens 26B that is a positive lens, in this order from a side of the excitation light sources 21 toward a side of the phosphor wheel 27. The second optical system 26 guides the excitation light P converted into the circular polarized light and being incident thereon from the ¼ wave plate 25 to the phosphor wheel 27 while converging the excitation light B. The excitation light P guided from the second optical system 26 is incident on the phosphor wheel 27.

The phosphor wheel 27 corresponds to a wavelength conversion unit (or a wavelength converter) that receives light emitted from an excitation light source 21 and emits light having a wavelength different from the wavelength of the light emitted from the excitation light source 21. As illustrated in FIGS. 3 and 4, the phosphor wheel 27 includes a disc member 27A and a drive motor 27C that rotationally drives the disc member 27A about a rotation shaft 27B. For the disc member 27A, a transparent substrate or a metal substrate, for example, can be used. However, it is not limited to these options. As the metal substrate, an aluminum substrate can be used.

The phosphor wheel 27 is divided into the phosphor region 27D in the circumferential direction. In embodiments, the fluorescent region is an angular range larger than 270 degrees. In FIG. 3, the phosphor region 27D is 360 degrees. The phosphor region 27D includes a reflection coat, a phosphor layer, and an anti-reflection coat layered in this order from a lower-layer side toward an upper-layer side.

The reflection coat has a characteristic of reflecting light in a wavelength region of fluorescence Y by the phosphor layer. When the disc member 27A is made of a metal substrate with high reflectance, the reflection coat may be omitted. Further, the disc member 27A may serve as the reflection coat.

The phosphor layer may use, for example, a substance in which a fluorescent-body material is dispersed into an organic or inorganic binder, a substance in which a crystal of a fluorescent-body material is directly formed, or a rare-earth fluorescent body such as a Ce:YAG-based substance. The fluoresce Y emitted from the phosphor layer may be in a band of wavelengths of yellow and green, for example. In the present specification, a case where the fluoresce Y in the yellow wavelength band is used will be described as an example. The wavelength conversion unit is not limited to the phosphor wheel 27, and a phosphor, or a nonlinear optical crystal may be used.

The anti-reflection coat has a characteristic of preventing light reflection on the surface of the phosphor layer.

A reflection coat having a characteristic of reflecting light in the wavelength region of the excitation light P guided from the second optical system 26 is layered on the excitation-light reflective region 27E. When the disc member 27A is made of a metal substrate with high reflectance, the reflection coat may be omitted. Further, the disc member 27A may serve as the reflection coat.

The disc member 27A is rotationally driven by the driving motor 27C. Thus, the irradiation position with the excitation light P on the phosphor wheel 27 moves over time. As a result, a part of the excitation light P incident on the phosphor wheel 27 is converted into the fluorescence Y having a different wavelength from that of the excitation light P in the phosphor region 27D (wavelength conversion region) and then emitted.

As illustrated in FIG. 5, most of the light emitted from the light source unit 20 is yellow light having wavelengths of 510 nm or more and 610 nm or less and high visibility. The other wavelengths are also included in the range of 428 nm or more and 688 nm or less, which falls within the visible light range. Thus, the light source unit 20 can deliver light with excellent visibility to the image projection apparatus 1.

In this specification, the term “majority” refers to a condition where the radiant energy of light in the wavelength range from 510 nm to 610 nm, corresponding to green to yellow light, is denoted as A (W). Meanwhile, the radiant energy of light having wavelengths below 510 nm is denoted as B (W), and that of wavelengths above 610 nm is denoted as C (W). The condition is satisfied when A>B and A>C.

As illustrated in FIG. 2, the excitation light P incident on the phosphor region 27D of the phosphor wheel 27 is converted into fluorescence Y and is emitted. The fluorescence Y is collimated into substantially parallel light by the second optical system 26, passes through the ¼ wave plate 25 and the polarization beam splitter 24, then through a condenser lens 28, and enters the light homogenizer 30.

When the excitation light source is exclusively used for excitation, such as using blue light and not for illumination, the quarter-wave plate 25 is not used. Additionally, the polarization beam splitter 24 may also function as a dichroic mirror that reflects the wavelength band of the excitation light and transmits the wavelength band of the fluorescence.

The fluorescence Y is guided from the light homogenizer 30 through the illumination optical system 40 to the image display element 50 to form an image. This image is then magnified and projected onto the screen 70 by the projection optical system 60, resulting in an image formed by the fluorescence Y, that is, a monochromatic yellow image. Although yellow phosphor is used in FIG. 2, a green monochromatic image can be obtained when a green phosphor is used. The monochromatic image is an image represented by the density (brightness) of monochromatic light having a certain spectral distribution. The light and shade can be generated by controlling the brightness of each pixel by the image display element 50.

In the simplest configuration for performing full-color display using a single-plate DMD system, an image projection apparatus that outputs the minimum set of single colors R (red), G (green), and B (blue) is used for calculation. The ratio of each color when displaying the R, G, and B images in one frame is applied to an image projection apparatus where one frame corresponds to 360 degrees of one cycle of the color wheel, with each color evenly distributed across 120 degrees.

A single color is obtained for a time of 120 degrees for each color. However, the illumination light of each color spreads and overlaps with other colors at the boundaries due to its spot size, causing color mixing. To address this, a spoke time (SP) is applied, during which the signal for the overlapping portion is turned off. The typical SP duration is about 5 to 15 degrees. For example, if the spot size is 10 degrees, an image projection apparatus designed with an equal angle for each color allocates 110 degrees to each of red, green, and blue (RGB), plus three SPs of 10 degrees each, resulting in a total of 360 degrees. The ratio of R:G:B is 11:11:11:3. When the total radiant energy is 1, R is 11/36, G is 11/36, B is 11/36, and SP is 3/36. For example, consider a case where the design is based on a brightness of 5000 lumens.

Since the RGB single colors are distributed across wavelengths rather than being confined to a monochromatic dominant wavelength, they cannot be calculated directly. However, for simplicity in explaining the effect, B and R are each set to 0.2 relative to 1 for G, based on visibility characteristics. In other words, for 5000 lumens, the portion excluding 3/36 (or 1/12) for the SP, amounting to 4583 lumens, represents the total output when RGB colors are individually emitted as single colors. In other words, R and B each account for 655 lumens, and G accounts for 3273 lumens.

In FIG. 2, monochromatic light is projected. Specifically, single-wavelength light in the green to yellow region is used as the emitted light. All the time periods allocated to R and B can be assigned to the G region. Since the relative luminous efficiency of B and R is approximately 0.2, when the same radiant energy as R and B is output as G, the perceived brightness is five times greater than that of R and B. In other words, the brightness is five times 655 lumens, resulting in 3274 lumens from R to G, 3274 lumens from B to G, and 3274 lumens from the original G. This totals to 3274 lumens×3=9822 lumens.

Since all the SP portions can also be projected with G, at least an additional 417 lumens ( 1/12 of 5000 lumens) will be added, resulting in a total of 10,238 lumens, further enhancing the brightness. In practice, there is a practical restriction that a time for temporarily turning off the driving of the DMD is provided. However, it can be understood that using a single color, particularly in the green to yellow range, significantly enhances brightness. By designing an image projection device, originally intended to output full-color images at a desired brightness, to primarily project light in the green wavelength range, it is possible to achieve nearly double brightness.

Another example of a configuration of a light source unit included in an image projection apparatus will be described with reference to FIGS. 6 to 10. Identical names and reference signs as in the above discussion represent identical or equivalent members or components, and detailed description thereof is appropriately omitted.

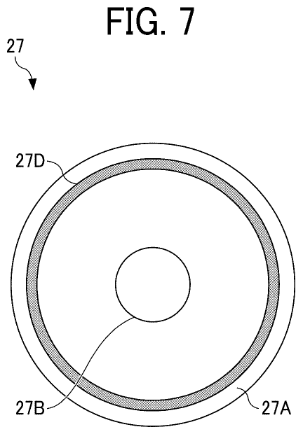

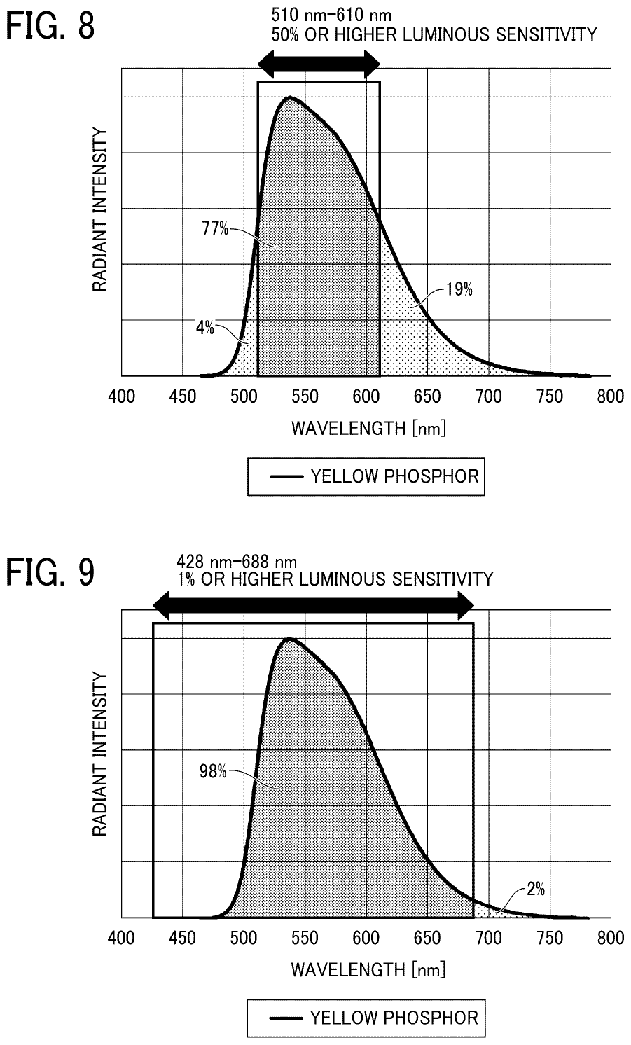

FIG. 6 is a schematic diagram of the another example light source unit 100 of the image projection apparatus 1. FIG. 7 is a diagram illustrating a configuration of a phosphor wheel 27 included in a light source unit 100 in FIG. 6. FIG. 8 is a diagram of the ratio of the radiation intensity of the yellow fluorescence in each wavelength range of the light projected from the image projection apparatus 1, specifically illustrating the radiation intensity of 510 nm or more and 610 nm or less. FIG. 9 is a diagram of the ratio of the radiation intensity of the yellow fluorescence in each wavelength range of the light projected from the image projection apparatus 1, specifically illustrating the radiation intensity of 428 nm or more and 688 nm or less.

In FIGS. 6 to 8, the light source unit 100 includes a dichroic mirror 29 that reflects blue light and transmits fluorescence Y. This differs from the light source unit 20 in FIG. 2, which includes polarization beam splitter 24.

A case will be considered where a blue light source is used to excite a phosphor, emitting fluorescence Y within a wavelength band ranging from green to yellow. In this case, there are four monochromatic colors: R (red), G (green), B (blue), and Y (yellow). For example, the ratio of each single color (single color luminance ratio) when white light is obtained by mixing the colors R, G, B, and Y is expressed as R:G:B:Y=0.08:0.3:0.03:0.3. The difference of 0.29 between the total of R, G, B, and Y and I corresponds to the spoke time. As the luminous flux amount, when the brightness of the image projection apparatus 1 is 5000 lumens, the brightness of R is 400 lumens, the brightness of G is 1500 lumens, the brightness of B is 150 lumens, and the brightness of Y is 500 lumens. On the other hand, the radiation energy ratio is R:G:B:Y=0.10:0.16:0.26:0.17, with the spoke time being 0.30.

In contrast, as in the configuration illustrated in FIG. 6, when the total of R, G, and B, excluding Y, is 0.1+0.16+0.26=0.52, and this entire amount is allocated to Y, the calculation is 0.52/0.17×1500=4588, resulting in an increase of 4588 lumens. In other words, the image projection apparatus 1 achieves a brightness of 1500+4588=6088 lumens, representing an enhancement of 6088 lumens.

In the radiation energy ratio, the Y component accounts for 0.36 or more, exceeding the total of 0.1 for R and 0.26 for B. Furthermore, even when the values of R and B are each doubled, the total becomes 0.2 or 0.52, which is still at least 0.52 or more compared to the Y component. Further, when 0.3 of the spoke time is also allocated to the radiation power of Y, the calculation 0.3/0.17×1500=2647 indicates that the radiation power is further enhanced by 2647 lumens. Further, the lumen increases to 6088+2048=8735 lumens, representing an enhancement to 1.75 times, and the radiation energy ratio is further expanded beyond 2 times. When almost all of B is converted into the Y component, the ratio of the Y component to the B component becomes infinitely large.

In the case of the fluorescence Y, as illustrated in FIG. 8, the energy E1 in the range of 510 nm to 610 nm is 77%, the energy E2 of less than 510 nm is 4%, and the energy E3 above 610 nm is 19%.

Since E1 (77%)>E2 (4%), E1 (77%)>E3 (19%), and E1 (77%)>E2 (4%)+E3 (19%), it can be concluded that most of the emitted light consists of green to yellow light with a high luminosity factor and wavelengths of 510 nm or more and 610 nm or less. Further, since E1 (77%)>2×E2 (19%×2) and E1 (77%) >2×E3 (4%×2), the monochromatic lights within the more desirable wavelength bands can be obtained.

As illustrated in FIG. 9, the radiation energy in the visible light range from 428 nm to 688 nm is 98% of the total energy of the fluorescence Y. Thus, it can be said that the fluorescence Y has wavelengths within the visible light range, and most of the radiation energy is useful for visual recognition. In other words, it can be said that the fluorescence Y is efficient light for achieving a brighter and more easily viewable projection image.

### Projection Optical System 60

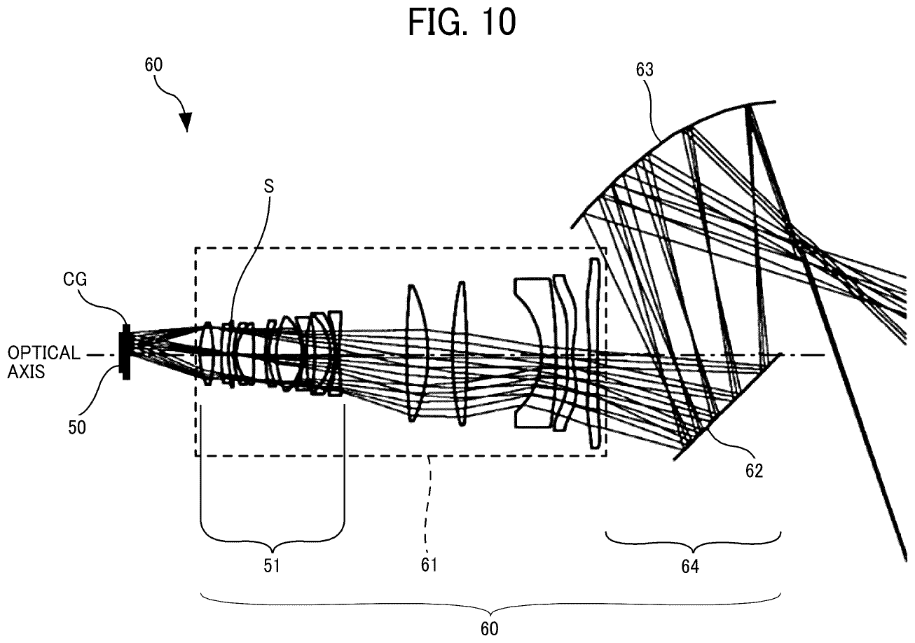

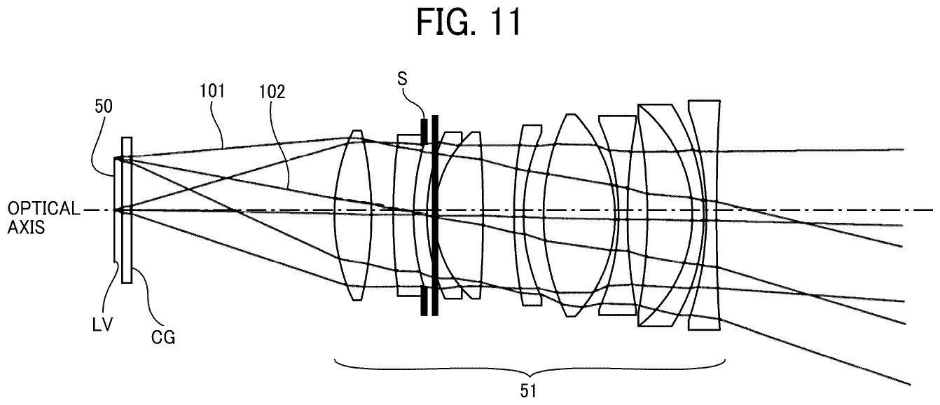

A projection optical system 60 included in an image projection apparatus 1 will be described with reference to FIGS. 10 and 11. FIG. 10 is a diagram illustrating a configuration of a projection optical system 60 included in the image projection apparatus 1. FIG. 11 is a schematic view illustrating an example of a configuration of the multiple lenses 51 included in the image projection apparatus 1.

FIG. 10 illustrates an image display clement 50 and the projection optical system 60. FIG. 11 is an enlarged illustration of the image display element 50 of FIG. 10 and multiple lenses 51 that form part of a refractive optical system 61 within the projection optical system 60. The image display element 50 includes an image forming unit LV as a portion that forms an image to be projected. In the image display element 50, the image formed on the image forming unit LV is illuminated by the illumination light from the illumination optical system 40.

In the following description, a DMD is assumed as the image display element 50, and an image display clement without the function of emitting light on its own will be described. The projection optical system 60 is not limited to this aspect. A self-emitting type that can emit light from a generated image may be used, or a light valve other than the DMD may also be utilized. In addition, the projection optical system 60 may include a combination of components such as an illumination device, a mirror, dustproof glass, and others, as long as the image display element 50 and the projection optical system 60 are incorporated.

As illustrated in FIG. 10, a parallel plate CG is positioned close to the image forming unit LV of the image display element 50. The parallel plate CG is a flat plate that transmits light and is a cover glass (or seal glass) of the image forming unit LV. The projection optical system 60 enlarges and projects an image formed by the image forming unit LV on a screen 70 (see FIG. 1), and includes a refractive optical system 61 including multiple lenses 51 and a reflective optical system 64 including a reflecting surface having power in order from the image forming unit LV toward the screen 70. The multiple lenses 51 illustrated in FIG. 11 include an aperture stop S. The light, including an upper light beam 101 and a principal light beam 102, emitted from the image forming unit LV and transmitted through the parallel plate CG travels along the optical path illustrated in FIG. 10. The light passes through the multiple lenses 51, continues through the refractive optical system 61, and is then projected onto a screen 70 via the reflective optical system 64 that includes the reflective mirror 62 and a curved mirror 63.

For example, by designing the reflectance characteristics of the reflective mirror 62 and the curved mirror 63 to achieve high reflectance in the wavelength band of the projection light, it is possible to create an image projection apparatus with increased brightness and enhanced visibility. In particular, it is known that the curved mirror 63 generates heat generates heat from light that is not reflected, leading to deformation of the mirror and a subsequent deterioration in image quality. Such a situation can be prevented by increasing the reflectance, resulting in projected images that are easier to view.

### Mirror and Lens of Image Projection Apparatus 1

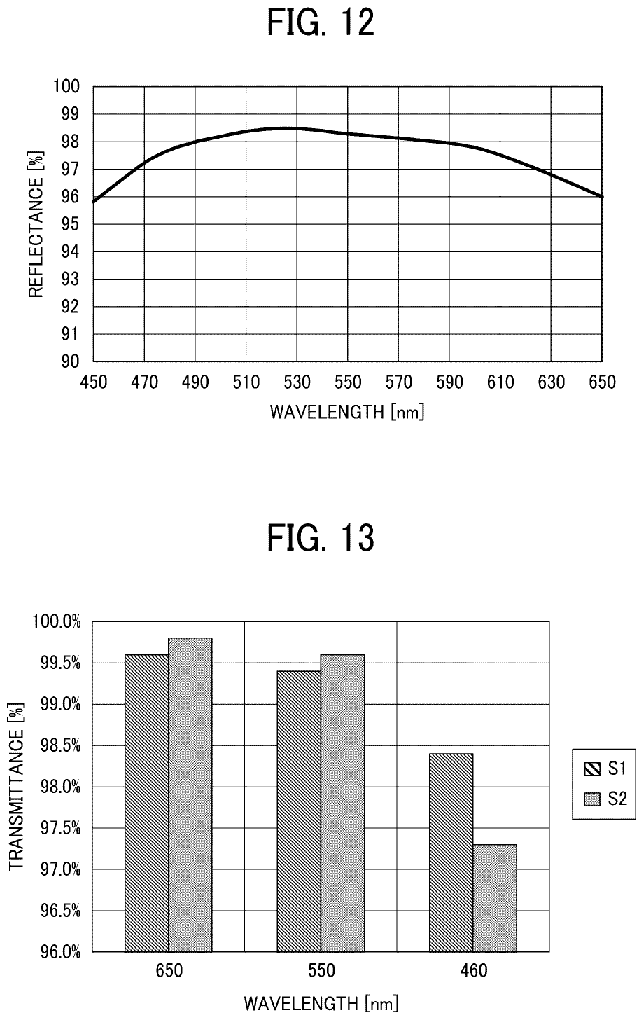

FIG. 12 is a diagram illustrating the relation between wavelength and reflectance of a mirror included in the image projection apparatus 1. FIG. 13 is a diagram illustrating the relation between wavelength and transmittance of a lens included in the image projection apparatus 1.

FIG. 12 illustrates the reflectance in the mirror design results, where high reflectance is achieved in the wavelength band of the light projected by the image projection apparatus 1. Ideally, a mirror with 100% reflectance across all wavelength bands would be used, but achieving this is challenging. Designing or selecting a mirror involves determining a wavelength band in which high reflectance is desired to be secured and a wavelength band in which high reflectance can be sacrificed. In the reflectance characteristics of FIG. 12, the reflectance of approximately 510 nm or more and 550 nm or less, where the intensity is high in the spectral distribution of fluorescence Y as illustrated in FIG. 5, is higher than the reflectance at 450 nm or 650 nm. In other words, the projection optical system 60 includes reflective mirror 62 and/or curved mirror 63 which have reflectance for light having wavelengths of 510 nm or more and 610 nm or less which is higher than its reflectance for light having wavelengths of 450 nm or 650 nm. By adopting such mirrors, a bright projection image with enhanced visibility can be achieved. The mirrors are not limited to those included in the projection optical system 60. For mirrors included in at least one of the projection optical system 60 and the light source unit 20/100, the reflectance for light having wavelengths of 510 nm or more and 610 nm or less may be higher than the reflectance for light having wavelengths of 450 nm or 650 nm.

To achieve the characteristics of reflective mirror 62 and/or curved mirror 63 as presented in FIG. 12, for example, techniques such as applying a reflection coating to the mirror are involved. For example, a method involving depositing aluminum on a resin substrate and coating its surface with a reflection-enhancing film can be mentioned.

However, a different method may also be used, such as using silver instead of aluminum. The mirror with the characteristics illustrated in FIG. 12 can be applied to the projection optical system 60, the mirror in the light source unit 20/100, the micromirror in the image display element 50, and similar components.

Among the radiation energy of the light projected as the image displayed by the image display element 50, the radiation energy in the wavelength range from green to yellow (510 nm to 610 nm) is defined as A′, and the radiation energy outside this range is defined as (B′+C′). In this case, adopting the mirror with the characteristics illustrated in FIG. 12 in the projection optical system 60 enables the image projection apparatus 1 to efficiently project light within the waveband of 510 nm or more and 610 nm or less, which has high visibility. This can be achieved by configuring the projection optical system 60 to satisfy the condition

A/(B+C)<=A′/(B′+C′). Note that A/(B+C)<=A′/(B′+C′) indicates that the loss of radiation energy in the wavelength of 510 nm or more and 610 nm or less within the projection optical system 60 or similar components is smaller than the loss in other wavelength regions.

The transmittance characteristics of the glass material used for the lens included in the image projection apparatus 1 include, for example, glass materials such as a glass material S1 and a glass material S2, as illustrated in FIG. 13. When the wavelength is 460 nm, the transmittance of the glass material S2 is higher than that of the glass material S1. When the wavelengths are 550 nm or 650 nm, the transmittance of the glass material S1 is higher than that of the glass material S2. In other words, the projection optical system 60 includes a lens, where the transmittance of the lens for light having wavelengths of 510 nm or more and 610 nm or less is higher than its transmittance for light having a wavelength of 450 nm. For example, a glass material such as glass material S2, which has high transmittance for 550 nm light with high visibility, is suitable for the projection optical system 60. Using a lens made of such glass material S2 enables an image projection apparatus to project bright images with high visibility. The lens included in at least one of the projection optical system 60 and the light source unit 20 is not limited to the lens in the projection optical system 60. The transmittance of the lens for light having wavelengths of 510 nm or more and 610 nm or less may be higher than its transmittance for light having wavelengths of 450 nm or 650 nm.

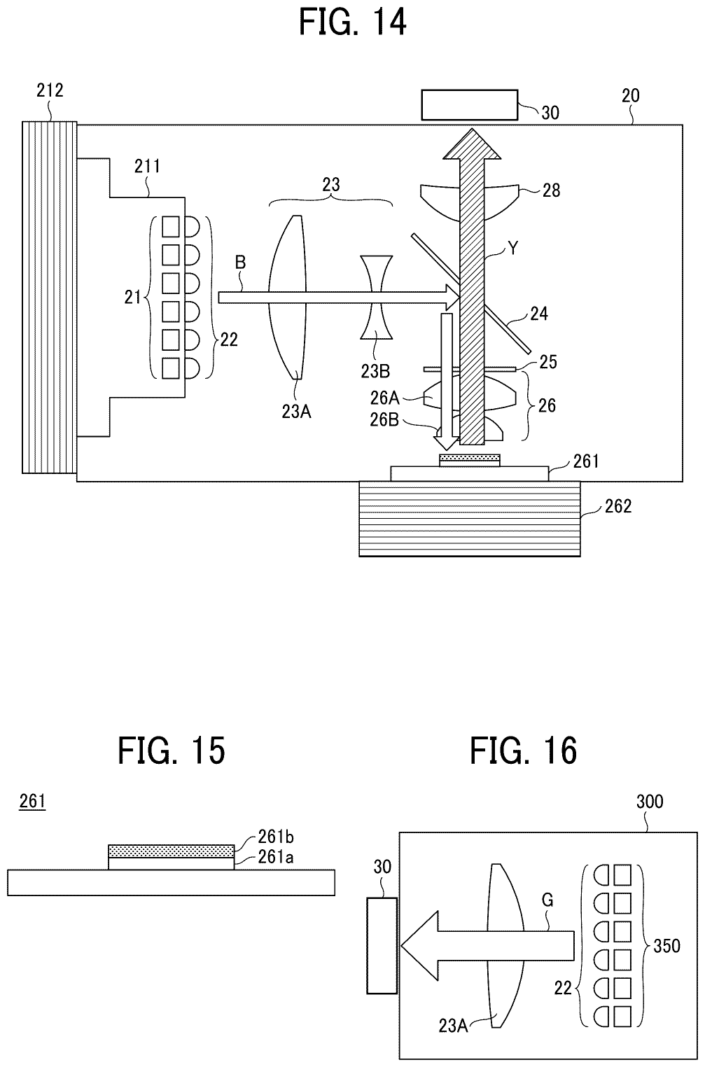

Other features of an image projection apparatus will be described with reference to FIGS. 14 and 15. FIG. 14 is a schematic diagram of a configuration of a light source unit of the image projection apparatus. FIG. 15 is a schematic diagram of a configuration of a static phosphor unit 261 included in the image projection apparatus.

As illustrated in FIG. 14, the light source unit 20 includes a static phosphor unit 261 that is not rotationally driven, a first cooler 212 that cools the excitation light source 21 in the light source unit 20, and a second cooler 262 that cools the static phosphor unit 261.

FIG. 15 is a side view of the static phosphor unit 261, viewed in an orthogonal direction that is orthogonal to the incident direction of blue light. As illustrated in FIG. 15, the static phosphor unit 261 is configured by stacking a phosphor 261b that is a wavelength-converting material, on a reflecting member 261a that reflects the exciting light. For example, when viewed from the incident direction of the blue light, the reflecting member 261a and the phosphor 261b have a substantially rectangular outer edge shape. The phosphor 261b is applied onto the reflecting member 261a.

The static phosphor unit 261 corresponds to a wavelength conversion unit that receives light emitted from an excitation light source and emits light having a wavelength different from the wavelength of the light emitted from the excitation light source. When blue light is incident on the static phosphor unit 261, the blue light serves as excitation light for the phosphor 261b and is wavelength-converted by the phosphor 261b. Thus, for example, fluorescence Y having a yellow wavelength range with a peak emission intensity at 550 nm is generated. This fluorescence Y is Lambert-reflected through the action of the phosphor 261b and the reflecting member 261a. The Lambertian reflection is a type of reflection where light is scattered uniformly in all directions, regardless of the angle of incidence.

A part of the blue light incident on the static phosphor unit 261 does not act as the excitation light, and is reflected by the reflecting member 261a. Thus, when the blue light is incident on the static phosphor unit 261, both the blue light and the fluorescence Y are simultaneously emitted. The fluorescence Y emitted from the static phosphor unit 261 corresponds to light that satisfies A>B and A>C, where A is the radiation energy of light having wavelengths of 510 nm or more and 610 nm or less, B is the radiation energy of light having wavelengths less than 510 nm, and C is the radiation energy of light having wavelengths greater than 610 nm.

The static phosphor unit 261 does not rotate, unlike the phosphor wheel 27 in FIG. 2. The second cooler 262 can be connected to or attached to the surface of the reflecting member 261a opposite to the surface on which the phosphor 261b is laminated. By connecting the second cooler 262 to that surface, heat generation of the phosphor 261b is reduced or prevented, enabling higher wavelength-conversion efficiency. As a result, it becomes possible to provide an image projection apparatus that projects brighter and more easily viewable images.

The light source unit 20 illustrated in FIG. 14 is a packaged unit that houses multiple excitation light sources 21 within a light source housing 211. For example, the first cooler 212 is positioned on the side of the light source unit 20 opposite to the surface from which the excitation light is emitted. This helps reduce the heat generated by the excitation light source 21. The first cooler 212 may be made of a metal member or a carbon member having excellent heat conductivity. Since the excitation light source 21 has a temperature characteristic where the light emission increases as the temperature decreases, using the first cooler 212 to cool the excitation light source 21 enhances its light emission efficiency. This allows the image projection apparatus 1 to project brighter and more easily viewable images.

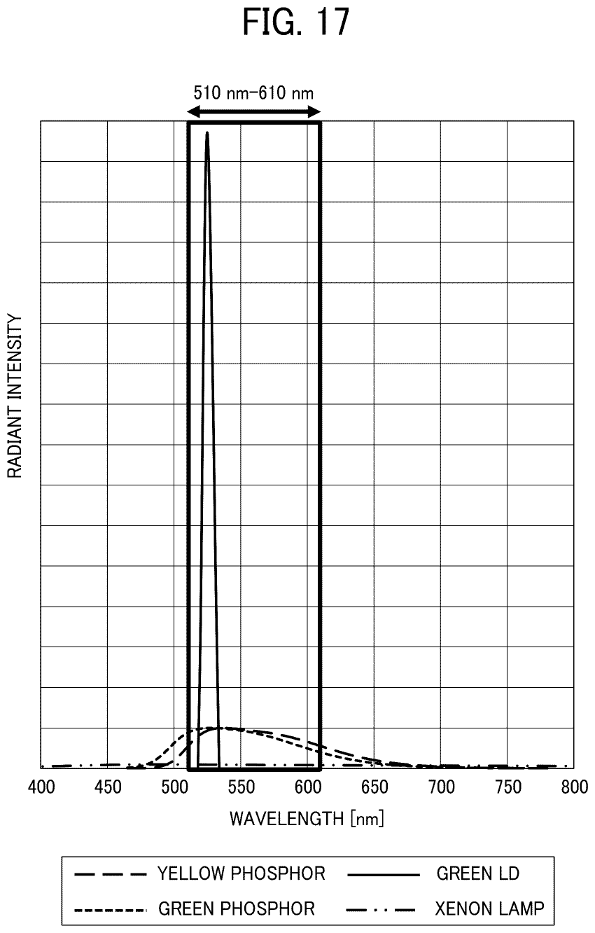

Other features of an image projection apparatus will be described with reference to FIGS. 16 to 18. FIG. 16 is a schematic diagram of a configuration of a light source unit 300 of the image projection apparatus. FIG. 17 is a diagram of a spectral distribution of light emitted from a light source unit 300.

The light source unit 20 as shown in FIG. 16 emits green light G, while the light source unit 20 as shown in FIG. 2 emits excitation light P which is blue light.

As illustrated in FIG. 16, the green light G emitted from each of multiple excitation light sources 350 is adjusted to become substantially parallel by a corresponding collimator lens 22, focused by a first lens 23A, and then directed into a light homogenizer 30. The behavior of the light after exiting the exit of the light homogenizer 30 is the same as that of FIG. 1. The green light G is guided from the light homogenizer 30 to the image display element 50 through the illumination optical system 40. The image projection apparatus can display a green monochromatic image by enlarging and projecting the image displayed on the image display element 50 onto the screen 70 using the projection optical system 60.

The excitation light sources 350 for emitting the green light G may include a source for emitting laser light of wavelengths in 525 nm, a source for emitting laser light of wavelengths in 532 nm, a source for emitting laser light of wavelengths in 518 nm, or a combination of these sources. By combining the green excitation light sources 350 having different wavelengths, the color of green can be adjusted according to the color or material of the screen 70 or the preference of the viewer, and thus the visibility can be further enhanced. The excitation light sources 350 is not limited to one that emits green light G, and an image projection apparatus with excellent visibility can be achieved as long as the wavelengths are of 510 nm or more and 610 nm or less.

The excitation light source 350 emits green light G in a very narrow wavelength band, as in the spectral distribution illustrated in FIG. 17. Since all the light energy of the green light G falls within the region of high relative luminous efficiency, the energy A of 510 nm or more and 610 nm or less is 100%, whereas the energy B below 510 nm and the energy C above 610 nm are both 0% This allows the image projection apparatus 1 to project much brighter and much more easily viewable images.

The conditions are satisfied: A (100%)>B (0%) and A (100%)>C (0%), and since A (100%)>B (0%)+C (0%). The light can be described as satisfying the conditions A>B and A >C, where A represents the radiation energy of light having wavelengths of 510 nm or more and 610 nm or less, B represents the radiation energy of light having wavelengths below 510 nm, and C represents the radiation energy of light having wavelengths above 610 nm. Further, since A (100%)>2B (0%×2) and A (100%)>2×C (0%×2), it can be said that the light is a monochromatic light within a more desirable wavelength range. The image projection apparatus enhances brightness further by incorporating the first cooler 212 illustrated in FIG. 14.

Although some embodiments have been described in detail, the present disclosure is not limited to the above-described embodiments, and various modifications and substitutions can be made to the above-described embodiments without departing from the scope of the claims.

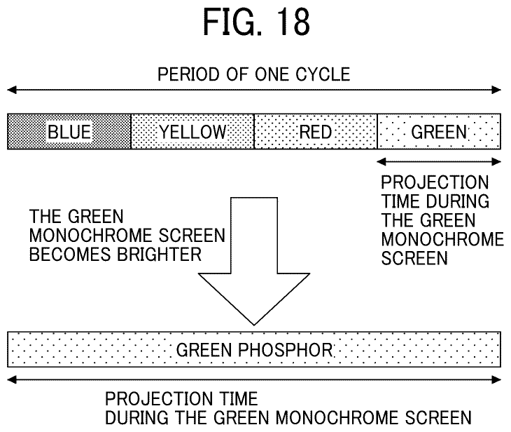

For example, in FIGS. 16 and 17, the brightness of the projection light is enhanced. FIG. 18 is a diagram illustrating color distribution per cycle in the Digital Light Processing (DLP) method. In a DLP-type image projection apparatus, since light is projected in a time-division manner for each color, wavelengths with high visibility are projected only during part of each cycle (one frame). In FIG. 18, projection is carried out during one-fourth of a single frame period. In order to project a bright image, it is ideal for light with high-visibility wavelengths to be emitted throughout 100% of the duration of one cycle (one frame). Projecting a single-color image allows light with high-visibility wavelengths to be emitted for the entire duration of one cycle (one frame).

All the numerals such as ordinal numbers and numbers used in the description of the embodiments are illustrative for specifically describing the technique of the present invention, and the present invention is not limited to the illustrated numerals. In addition, a connection relation between the components is an example for specifically describing the technology of the present disclosure, and a connection relation for implementing a function of the present disclosure is not limited thereto.

Various examples of the image projection apparatus are described below.

### Head-Mounted Display Device

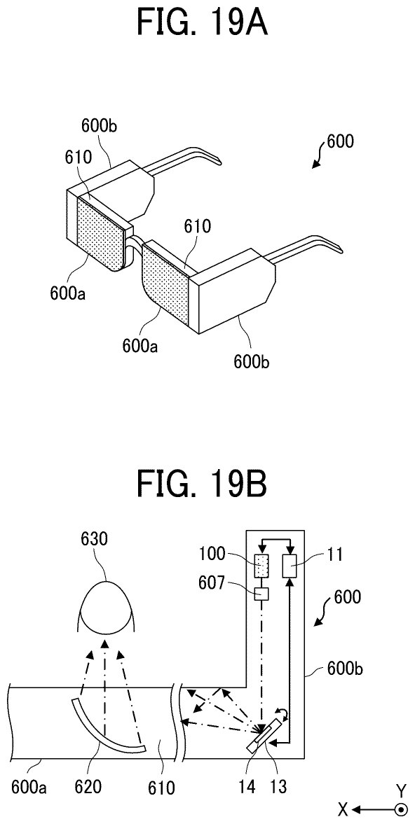

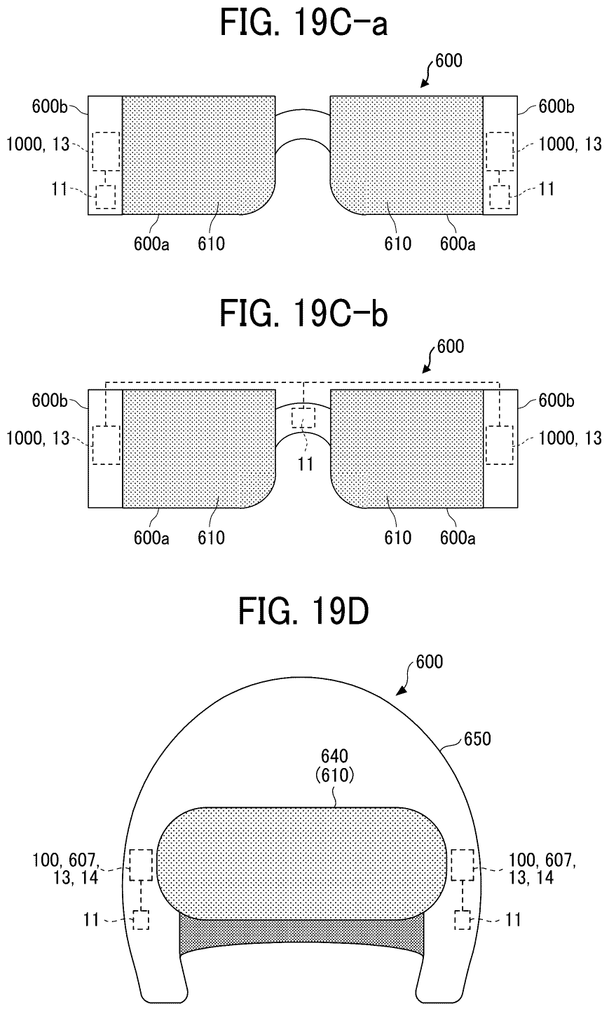

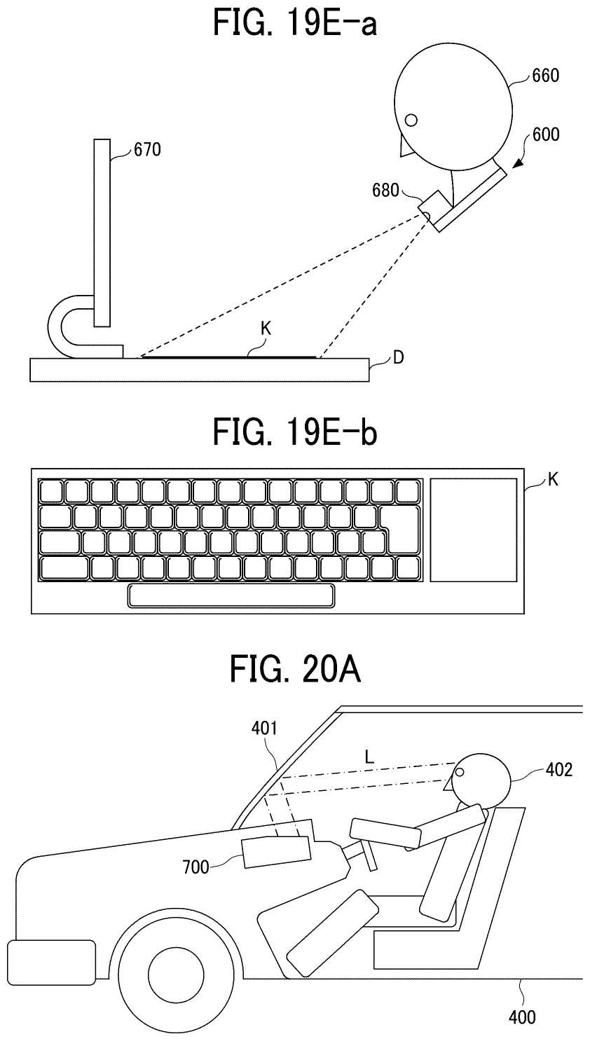

FIG. 19A is a schematic perspective view of a configuration example of a wearable display device 600 that is an example of a projecting apparatus. FIG. 19B is a schematic view of a part of the wearable display device 600 illustrated in FIG. 19A.

The illustrated wearable display device 600 is a head-mounted display, resembling glasses or goggles, that can be worn on a human head. In FIG. 19A, the wearable display device 600 is configured with a pair of front portions 600a and temple portions 600b, arranged substantially symmetrically on the left and right sides. Each of the front portions 600a has a light guide plate 610. An optical system, a controller, and other components are incorporated into each of the temple portions 600b.

FIG. 19B is an illustration of a part of the configuration of the wearable display device 600. Although the configuration for the left eye is illustrated in FIG. 19B, the wearable display device 600 has a configuration similar to that of the right eye.

The wearable display device 600 includes a control device 11, a light source unit 100 which is the light source device, a light-intensity adjuster 607, a movable device 13 having a reflecting surface 14, a light guide plate 610, and a semi-transparent mirror 620. In exemplary implementations, control device 11 includes circuitry. The functionality of the elements disclosed herein, such as control device 11, may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. Additionally, there is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC

The light source unit 100 integrates a laser light source, a collimator lens, a dichroic mirror, and other components within an optical housing.

The light intensity of light from the light source unit 100 is adjusted by the light-intensity adjuster 607, and the adjusted light is incident on the movable device 13. The movable device 13 moves the reflecting surface 14 in the XY-direction based on signals from the control device 11, enabling two-dimensional scanning of the light emitted from the light source unit 100. The drive control of the movable device 13 is synchronized with the light emission timing of the laser light source in the light source unit 100.

The scanning light of the movable device 13 is incident on the light guide plate 610. The light guide plate 610 reflects the scanning light on the inner wall and guides the scanning light to the semi-transparent mirror 620. The light guide plate 610 is formed from a material such as a resin having transparency at the wavelength of the scanning light.

The semi-transparent mirror 620 reflects light from the light guide plate 610 toward the rear surface of the wearable display device 600 and directs the light toward the eye 630 of the wearer of the wearable display device 600. The semi-transparent mirror 620 has, for example, a free-form surface shape. An image formed by the scanning light is reflected by the semi-transparent mirror 620 and projected onto the retina of the eye 630 of the wearer. Alternatively, the image is formed on the retina of the eye 630 of the wearer through the reflection by the semi-transparent mirror 620 and the lens effect of the crystalline lens of the eyeball. The crystalline lens is a part of the eyeball of a human. Further, the reflection by the semi-transparent mirror 620 can correct spatial distortion in the image. The wearer can observe an image formed by the light of scanning in the XY-direction. Using the semi-transparent mirror 620, the wearer can observe an image formed by light from the outside world superimposed with an image created by the scanning light. Alternatively, a regular mirror may replace the semi-transparent mirror 620 to block external light, allowing the wearer to see only the image created by the scanning light.

FIGS. 19C-a and 19C-b are schematic diagrams of another configuration example of the wearable display device 600.

As illustrated in FIG. 19C-a, a control device 1000 included in a wearable display device 600 is installed in each of the left and right temple portions 600b so as to correspond to the light source unit 100 and the movable device 13 incorporated in each of the left and right temple portions 600b.

Further, as illustrated in FIG. 19C-b, the control device 1000 may be installed at the central position (e.g., an intermediate position between the left and right light guide plates 610) of the wearable display device 600. Further, the control device 1000 may control the light source unit 100 and the movable device 13 incorporated into each of the temple portions 600b.

Further, the wearable display apparatus 600 may be in the form of a helmet 650 with a visor 640 including a light guide plate 610, as illustrated in FIG. 19D. In this case, the light source unit 100, the light-intensity adjuster 607, the movable device 13, the reflecting surface 14, and the control device 11 may be built in a helmet 650 as illustrated in FIG. 17D.

FIGS. 19E-a and 19E-b are schematic diagrams of another configuration example of the wearable display device 600. The wearable display apparatus 600 illustrated in FIGS. 19E-a and 19E-b is a neckband-type display apparatus designed to be worn around a neck or shoulder area of a person.

In FIG. 19E-a, a wearer 660 is sitting in front of a display 670 placed on a desk D while wearing a wearable display device 600. The display 670 communicates with the wearable display apparatus 600 via short-range wireless communication, such as Bluetooth, and outputs a display signal. The wearable display device 600 is equipped with a projector 680, which projects an image K of an input keyboard onto the upper surface of the desk D, as illustrated in FIG. 19E-b.

The wearable display apparatus 600 may include a camera in addition to the projector 680. The camera detects the movement of the fingers of the wearer 660 on the image K of the input keyboard projected on the desk D. Information on the detection result from the camera is transmitted to the control device of the wearable display device 600, for example. The control device then determines which key of the input keyboard is pressed by the wearer 660 based on the information received from the camera and instructs the display 670 to display information corresponding to the determination result.

### Head-Up Display Device

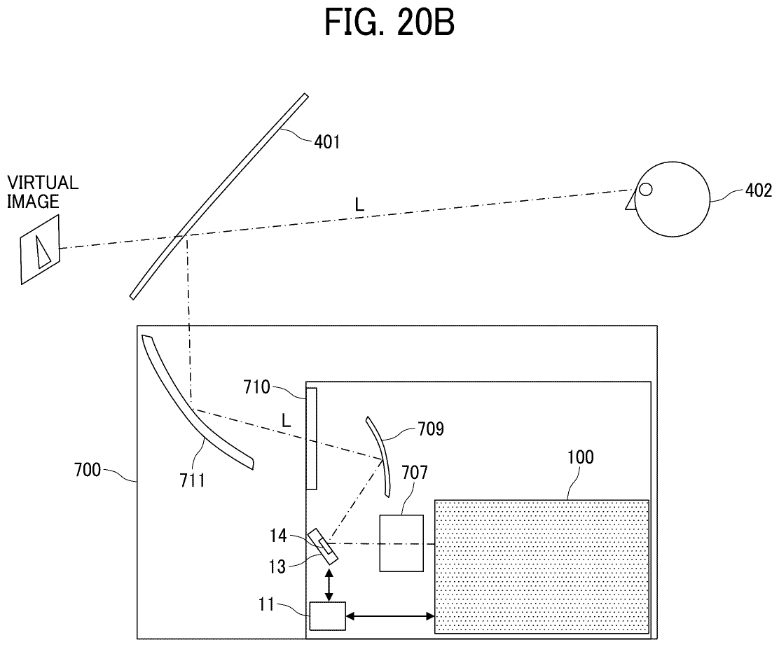

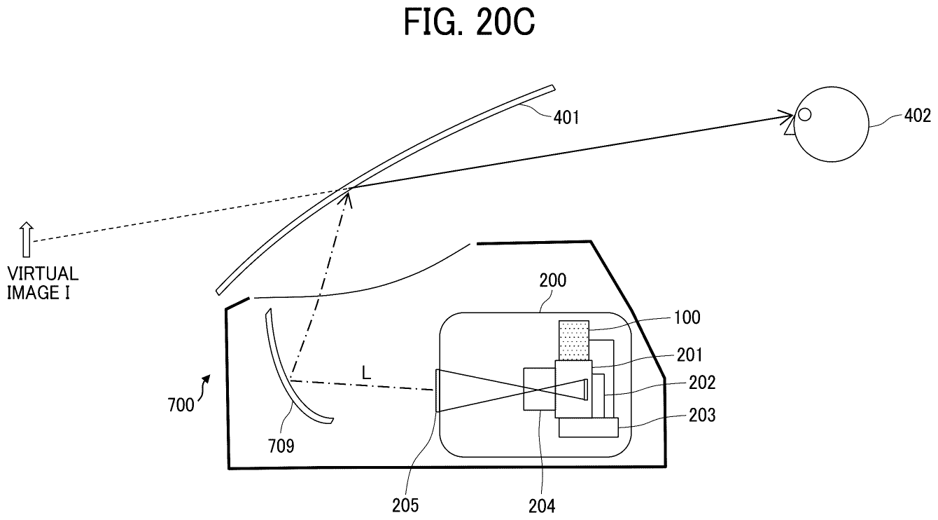

FIG. 20A is a schematic diagram of a vehicle 400 equipped with a head-up display device 700 which is an example of a projector. FIG. 20B is a schematic diagram of the head-up display device 700. The head-up display device 700 is, for example, a projector that projects an image by optical scanning.

As illustrated in FIG. 20A, the head-up display device 700 is disposed, for example, in the vicinity of a front windshield 401 of the vehicle 400. Projection light L emitted from head-up display device 700 is reflected by the front windshield 401 and is directed toward an observer (driver 402) who is a user. This allows the driver 402 to visually recognize, for example, an image projected by the HUD 700, as a virtual image. Alternatively, a combiner may be disposed on the inner wall surface of the front windshield 401 so that the user can visually recognize a virtual image formed by the projection light that is reflected by the combiner.

As illustrated in FIG. 20B, the head-up display device 700 includes the light source unit 100 which is a light source device. The light emitted from the light source unit 100 is deflected by the movable device 13 having the reflection surface 14 after passing through the light amount adjustor 707, for example. The deflected light is projected onto a screen through a projection optical system including a free-form surface mirror 709, an intermediate screen 710, and a projection mirror 711.

The head-up display device 700 projects the intermediate image displayed on the intermediate screen 710 onto the front windshield 401 of the vehicle 400, thereby causing the driver 402 to visually recognize the intermediate image as a virtual image.

The light emitted from the light source unit 100 is adjusted in intensity by the light amount adjustor 707, and then two-dimensionally scanned by the movable device 13 with the reflecting surface 14. The projection light L, which has been two-dimensionally scanned by the movable device 13, is reflected by the free-form surface mirror 709, corrected for distortion, and then focused onto the intermediate screen 710 to display an intermediate image. The intermediate screen 710 includes a microlens array in which microlenses are two-dimensionally arranged, and enlarges the projection light L incident on the intermediate screen 710 in units of microlens.

The movable device 13 causes the reflecting surface 14 to biaxially reciprocate and two-dimensionally scan with the light L incident on the reflecting surface 14. The drive control of the movable device 13 is synchronized with the light emission timing of the laser light source in the light source unit 100.

As illustrated in FIG. 20C, the head-up display device 700 includes an imager 200 and a free-form surface mirror 709. The imager 200 includes the light source unit 100 which is the light source device.

The light emitted from the light source unit 100 is, for example, directed to an image former 202 after passing through the illumination system 201. The image former 202 includes a light modulator, such as a micromirror device or a liquid crystal panel. A control device 203 controls light emission driving of the light source included in the light source unit 100 and driving of the light modulator included in the image former 202. The image generated by the image former 202 forms an intermediate image on an intermediate screen 205 by a projection lens 204.

The head-up display device 700 reflects the image formed on the intermediate screen 205 onto the front windshield 401 of the automobile via a free-form surface mirror 709 and causes the driver 402 to visually recognize a virtual image I. A turning mirror may be placed between the free-form surface mirror 709 and the front windshield 401 as needed in view of layout.

The intermediate screen 205 is configured by, for example, a microlens array in which microlenses are two dimensionally arranged. The microlens array is used to control the viewing angle characteristics, and enhances the viewing angle characteristics of the image projected onto the intermediate screen 205, generating a brighter virtual image.

The projector is not limited to the above configurations of the projector, the wearable display device, and the head-up display device. The projector is not limited to being mounted on an automobile or a human body, and may be mounted on, for example, a railroad vehicle, an aircraft, or a ship. The projector may be mounted on a mobile object such as a robot, a drone, or an unmanned aircraft capable of autonomous movement or remote operation movement, or a non-mobile object such as a work robot that operates a driving target such as a manipulator without moving from the place.

Aspects of the present disclosure are as follows, for example.

### Aspect 1

An image projection apparatus includes a light source to emit light; an image display element to modulate the light emitted from the light source to form an image with the modulated light; and a projection optical system to project the image formed by the image display element. Both the light emitted from the light source and the image projected by the projection optical system satisfy:
A>B and A>C, where
A denotes a radiation energy of light having a wavelength of 510 nm or more and 610 nm or less,
B denotes a radiation energy of light having a wavelength of less than 510 nm, and C denotes a radiation energy of light having a wavelength of greater than 610 nm.

### Aspect 2

In the image projection apparatus according to Aspect 1, the light source emits the light which satisfies A>B+C.

### Aspect 3

In the image projection apparatus according to Aspect 1 or 2, the light source emits light that satisfies at least one of A≥2B and A≥2C.

### Aspect 4

In the image projection apparatus according to any one of Aspects 1 to 3, the light emitted from the light source is a wavelength within a wavelength range of 428 nm or more and 688 nm or less.

### Aspect 5

The image projection apparatus according to any one of Aspects 1 to 4, at least one of the projection optical system or the light source includes a mirror, and the mirror has a higher reflectance for the light having a wavelength of 510 nm or more and 610 nm or less than for light having a wavelength of 450 nm or 650 nm.

### Aspect 6

In the image projection apparatus according to any one of Aspects 1 to 5, at least one of the projection optical system or the light source includes a mirror, and the mirror has a higher transmittance for the light having a wavelength of 510 nm or more and 610 nm or less than for light having a wavelength of 450 nm or 650 nm.

### Aspect 7

In the image projection apparatus according to any one of Aspects 1 to 6, the light source has a solid-state light source.

### Aspect 8

In the image projection apparatus according to any one of Aspects 1 to 7, the light source includes an excitation light source to emit first light having a first wavelength; and a wavelength converter to receive the first light emitted from the excitation light source; and emit a second light having a second wavelength different from the first wavelength.

### Aspect 9

The image projection apparatus according to Aspect 8, further includes a cooler to cool the excitation light source.

### Aspect 10

The image projection apparatus according to Aspect 9, further includes another cooler to cool the wavelength converter. The wavelength converter includes a static phosphor unit that is not rotationally driven.

### Aspect 11

In the image projection apparatus according to any one of Aspects 1 to 8, the wavelength converter includes a static phosphor unit that is not rotationally driven.

### Aspect 12

In the image projection apparatus according to Aspects 1 to 8, wherein the wavelength converter includes a phosphor wheel that rotates.

### Aspect 13

A head-mounted display includes the image projection apparatus according to any one of Aspects 1 to 12 and a guide plate.

### Aspect 14

The head-mounted display according to Aspect 13, further includes processing circuitry configured to adjust a light intensity of the light emitted from the light source.

### Aspect 15

The head-mounted display according to any one of Aspects 13 or 14, further includes a reflecting surface; and processing circuitry configured to adjust a light intensity of the light by controlling movement of the reflecting surface.

### Aspect 16

A head-up display mounted in a vehicle, incudes the image projection apparatus according to Aspect 1; and a projection mirror. The projection mirror reflects the image projected from the projection optical system.

### Aspect 17

In the head-up display according to claim 16, the image reflected by the projection mirror is projected on the windshield of the vehicle.

### Aspect 18

A head-mounted display includes a first image projection apparatus; and a second image projection apparatus. The first image projection apparatus and the second image projection apparatus each includes: a light source to emit light; an image display element to modulate the light emitted from the light source to form an image with the modulated light; and a projection optical system to project the image formed by the image display element, and for both the first image projection apparatus and the second image projection apparatus: both the light emitted from the light source and the image projected by the projection optical system satisfy A>B and A>C, where
A denotes a radiation energy of light having a wavelength of 510 nm or more and 610 nm or less,
B denotes a radiation energy of light having a wavelength of less than 510 nm, and
   C denotes a radiation energy of light having a wavelength of greater than 610 nm.

### Aspect 19

In the head-mounted display according to claim 18, for both the first image projection apparatus and the second image projection apparatus, the light source emits the light which satisfies A>B+C.

### Aspect 20

In the head-mounted display according to Aspect 18, for both the first image projection apparatus and the second image projection apparatus, the light source emits light that satisfies at least one of A≥2B and A≥2C.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An image projection apparatus, comprising:
a light source to emit light;
an image display element to modulate the light emitted from the light source to form an image with the modulated light; and
a projection optical system to project the image formed by the image display element, wherein
both the light emitted from the light source and the image projected by the projection optical system satisfy:
A>B and A>C, where
A denotes a radiation energy of light having a wavelength of 510 nm or more and 610 nm or less,
B denotes a radiation energy of light having a wavelength of less than 510 nm, and
C denotes a radiation energy of light having a wavelength of greater than 610 nm.

2. The image projection apparatus according to claim 1, wherein the light source emits the light which satisfies A>B+C.

3. The image projection apparatus according to claim 1, wherein the light source emits light that satisfies at least one of A≥2B and A≥2C.

4. The image projection apparatus according to claim 1, wherein the light emitted from the light source is a wavelength within a wavelength range of 428 nm or more and 688 nm or less.

5. The image projection apparatus according to claim 1, wherein
at least one of the projection optical system or the light source includes a mirror, and
the mirror has a higher reflectance for the light having a wavelength of 510 nm or more and 610 nm or less than for light having a wavelength of 450 nm or 650 nm.

6. The image projection apparatus according to claim 1, wherein
at least one of the projection optical system or the light source includes a mirror, and
the mirror has a higher transmittance for the light having a wavelength of 510 nm or more and 610 nm or less than for light having a wavelength of 450 nm or 650 nm.

7. The image projection apparatus according to claim 1, wherein the light source has a solid-state light source.

8. The image projection apparatus according to claim 1, wherein the light source includes:
an excitation light source to emit first light having a first wavelength; and
a wavelength converter to:
receive the first light emitted from the excitation light source; and
emit a second light having a second wavelength different from the first wavelength.

9. The image projection apparatus according to claim 8, further comprising:
a cooler to cool the excitation light source.

10. The image projection apparatus according to claim 9, further comprising:
another cooler to cool the wavelength converter, wherein
the wavelength converter includes a static phosphor unit that is not rotationally driven.

11. The image projection apparatus according to claim 8, wherein the wavelength converter includes a static phosphor unit that is not rotationally driven.

12. The image projection apparatus according to claim 8, wherein the wavelength converter includes a phosphor wheel that rotates.

13. A head-mounted display, comprising:
the image projection apparatus according to claim 1; and
a guide plate.

14. The head-mounted display according to claim 13, further comprising:
processing circuitry configured to adjust a light intensity of the light emitted from the light source.

15. The head-mounted display according to claim 13, further comprising:
a reflecting surface; and
processing circuitry configured to adjust a light intensity of the light by controlling movement of the reflecting surface.

16. A head-up display mounted in a vehicle, comprising:
the image projection apparatus according to claim 1; and
a projection mirror, wherein
the projection mirror reflects the image projected from the projection optical system.

17. The head-up display according to claim 16, wherein the image reflected by the projection mirror is projected on the windshield of the vehicle.

18. A head-mounted display, comprising:
a first image projection apparatus; and
a second image projection apparatus, wherein
the first image projection apparatus and the second image projection apparatus each includes:
a light source to emit light;
an image display element to modulate the light emitted from the light source to form an image with the modulated light; and
a projection optical system to project the image formed by the image display element, and
for both the first image projection apparatus and the second image projection apparatus:
both the light emitted from the light source and the image projected by the projection optical system satisfy A>B and A>C, where
A denotes a radiation energy of light having a wavelength of 510 nm or more and 610 nm or less,
B denotes a radiation energy of light having a wavelength of less than 510 nm, and
C denotes a radiation energy of light having a wavelength of greater than 610 nm.

19. The head-mounted display according to claim 18, wherein for both the first image projection apparatus and the second image projection apparatus, the light source emits the light which satisfies A>B+C.

20. The head-mounted display according to claim 18, wherein for both the first image projection apparatus and the second image projection apparatus, the light source emits light that satisfies at least one of A≥2B and A≥2C.
